(19) United States
(12) Patent Application Publication
(10) Pub. No.: US 2015/0042116 A1
(43) Pub. Date: Feb. 12, 2015

(54) ROCK PICKER IMPLEMENT ATTACHMENT

(71) Applicant: Northern Tool and Equipment Company, Inc., Burnsville, MN (US)

(72) Inventor: Scott Jacobson, Burnsville, MN (US)

(73) Assignee: NORTHERN TOOL AND EQUIPMENT COMPANY, INC., Burnsville, MN (US)

(21) Appl. No.: 14/328,297

(22) Filed: Jul. 10, 2014

Related U.S. Application Data
(60) Provisional application No. 61/844,790, filed on Jul. 10, 2013.

(51) Int. Cl. B66C 1/44

(52) U.S. Cl. CPC B66C 1/44; B66C 1/445
USPC 294/197; 294/104; 29/428

(57) ABSTRACT

An implement attachment includes a back plate member and a fixed arms member. The fixed arms member, the fixed arms member is fixedly coupled to the back plate member. A shiftable arm member is fixedly coupled to the back plate member and is shiftable relative to the fixed arms member to define a variable gap therebetween. A method of forming the implement attachment is further included.

### RELATED APPLICATIONS

This application claims the benefit of U.S. Provisional Patent Application No. 61/844,790, filed Jul. 10, 2013, said application being hereby fully incorporated herein by reference.

### TECHNICAL FIELD

The present invention is a plurality of attachments for a plurality of implements. More particularly, the implement attachment of the present invention is adapted for picking rock.

### BACKGROUND OF THE INVENTION

Referring to Prior FIGS. 17 and 18, two skid steer implements are depicted. The two skid steers 1500 are manufactured by different manufacturers. Each of the skid steer implements 1500 is mounted with a removable bucket 1502. Mounted on the side of the bucket 1502 that faces the skid steer implement 1500 are attaching devices that may be proprietary to each of the manufacturers of the skid steer implement 1500 for readily attaching and detaching the bucket 1502. By providing attaching devices similar to those on the bucket 1502, other attachments such as some of those disclosed in the present application may be attached to the skid steer implement 1500. The attachment 1502 (and additional attachments attached in place thereof) so attached is readily tiltable about an axis 1505 (see FIG. 18), the tilt axis 1505 being transverse to the longitudinal axis 1506 of the implement. The attachment is additionally elevatable by actuation of the lift arms 1507. Attachments of each of the implements of prior art FIGS. 17-21 are tiltable and elevatable in a manner similar to the manner noted above.

Referring to prior art FIG. 19, a schematic of the rear portion of a standard farm tractor 1520 is depicted. A 3-point hitch 1522 is mounted on the rear side of the tractor 1520. The 3-point hitch 1522 has a pair of spaced apart, shiftable lift arms 1524. A center arm 1526 is disposed above the lift arms 1524. Each of the lift arms 1524 and center arm 1526 are typically coupled to an attachment by means of a pin disposed in an eyelet. The pin is typically retained in place by a lynch pin. This means of attaching an implement to the tractor 1520 is time consuming, requiring the operator mount and dismount the tractor 1520 multiple times to effect the attachment.

Referring to prior art FIG. 20, a front end loader 1530 is depicted, mounting a removable bucket 1532. The bucket 1532 may be readily removed and replaced with a different kind of implement attachment in order for the front end loader 1530 to perform a plurality of different tasks.

Each of the implement attachments of the present invention is designed to be mounted on or operate with at least one of the above noted prior art implements.

There is a need for an implement attachment that may be readily attached to and disengaged from a particular implement and be utilized for picking rock. Such a rock picker should be able to be readily inserted in the soil with a minimum of effort exerted by the implement to which the rock picker is attached, engage the underside of a rock, grasp the rock, and hold onto the rock during elevation and removal of the rock.

### SUMMARY OF THE INVENTION

The attachment of the present invention meets the aforementioned needs of the industry. The attachment has a pair of parallel fixed spaced apart arms. These fixed arms member are forward directed with respect to a back plate member and are mounted thereto at an angle that is somewhat greater than a right angle. In this manner, the attachment need not be tilted downward to dispose the fixed arms member beneath a rock that is desired to be picked up. The attachment may be simply lowered with the back plate member generally horizontal. Forward motion of the implement (rearward motion of the tractor 1520) in concert with the weight of the attachment will drive the fixed arms member into the soil for disposition beneath a rock. The fixed arms member preferably cradle the rock between the fixed arms member.

A single shiftable arm member is disposed above the fixed arm member and positioned generally centrally between the spaced apart fixed arms member. The shiftable arm member is shiftable between an open, disengaged disposition and a closed, engaged disposition. The fixed arms member are driven beneath the rock to be picked up with the shiftable arm member being disposed in the open disposition. When the foxed arms are underlying the rock, the shiftable arm member may be rotated to the engaged disposition, thereby clamping the rock between the shiftable arm member and the fixed arms member. It is to be understood that more than a single shiftable arm member may be provided, as desired.

The present invention is an implement attachment that is a rock picker attachment and includes a back plate member and a fixed arms member. The fixed arms member, the fixed arms member is fixedly coupled to the back plate member. A shiftable arm member is fixedly coupled to the back plate member and is shiftable relative to the fixed arms member to define a variable gap therebetween. The present invention is further a method of forming the implement attachment.

### BRIEF DESCRIPTION OF THE DRAWINGS

FIG. 1 is a perspective view of a rock picker attachment according to the present invention;

FIG. 2 is a perspective view of a 3-point skid steer adapter plate;

FIG. 3 is a 3-point hitch with a 2 inch receiver adapter in perspective view;

FIG. 4 is a perspective view of a 70 inch utility rock bucket;

FIG. 5 is a perspective view of a 75 inch utility rock bucket;

FIG. 6 is a perspective view of a bale spear attachment;

FIG. 7 is a perspective view of a ballast box;

FIG. 8 is a perspective view of a bolt on root ripper;

FIG. 9 is a perspective view of a second embodiment of a root ripper;

FIG. 10 is a perspective view of a dual hitch receiver plate;

FIG. 11 is a perspective view of a heavy duty hitch receiver clamp;

FIG. 12 is a perspective view of a log skidder attachment;

FIG. 13 is a perspective view of pallet forks for a front end loader;

FIG. 14 is a perspective view of a quick spade attachment;

FIG. 15 is a perspective view of a skid steer 3-point attachment;

FIG. 16 is a perspective view of a grapple tree puller;

FIG. 17 is a perspective view of a prior art skid steer loader;

FIG. 18 is a perspective view of a prior art skid steer loader;

FIG. 19 is an elevational schematic depiction of a prior art 3-point hitch mounted on the rear of a tractor; and

FIG. 20 is a perspective view of a prior art front end loader.

### DETAILED DESCRIPTION OF THE DRAWINGS

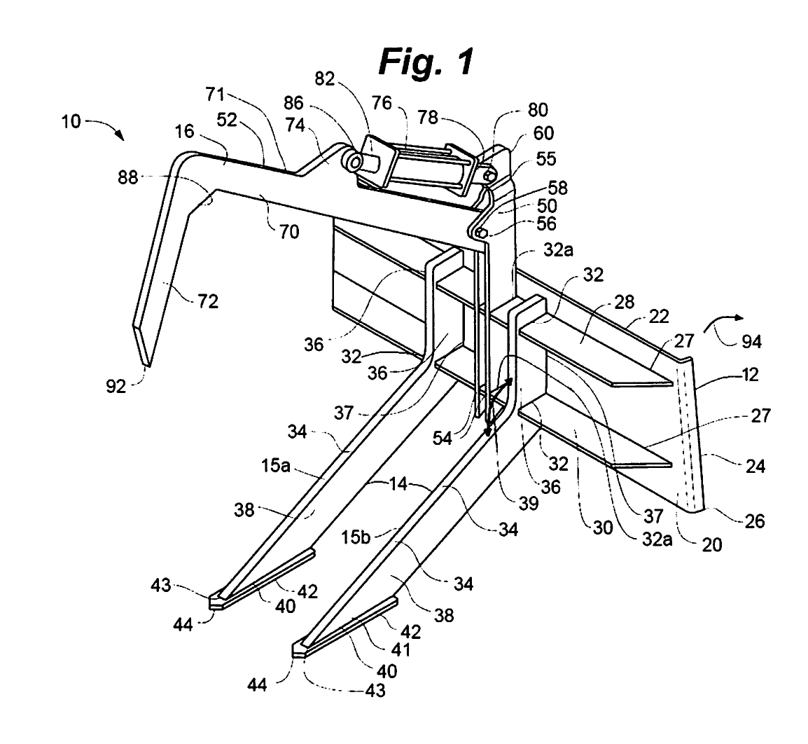

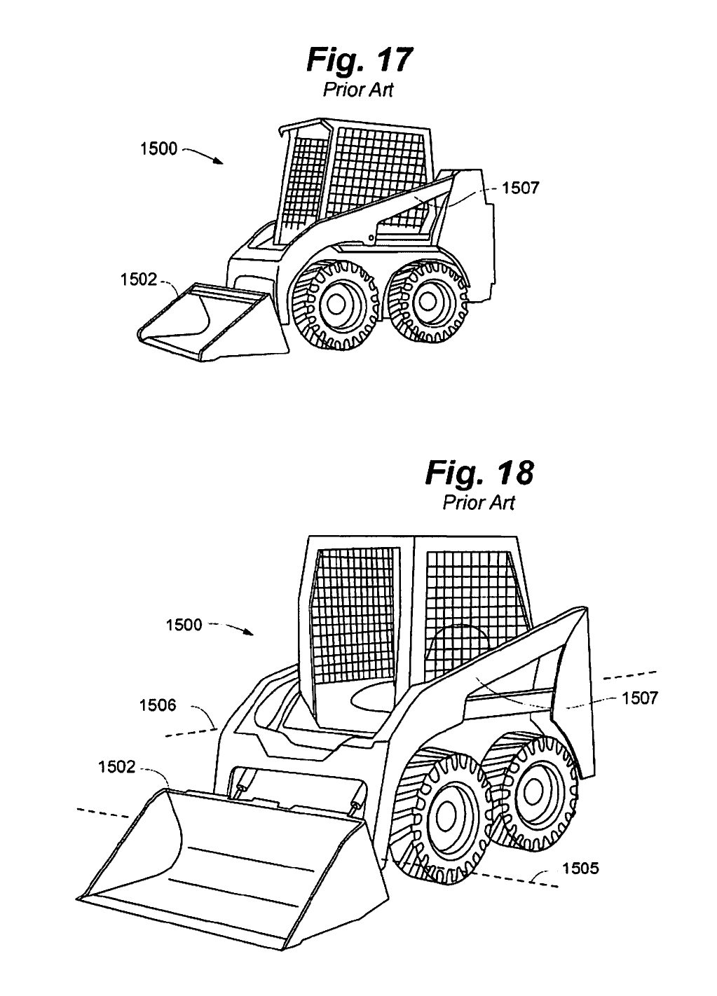

FIG. 1 depicts an embodiment of the implement attachment according to the present invention. The implement attachment of FIG. 1 is a rock picker attachment shown generally at 10. The rock picker attachment 10 is designed for use with a skid steer implement 1500, farm tractor 1520 and front end loader 1530 as depicted in prior art FIGS. 17-20. Rock picker attachment 10 has three major subcomponents; back plate member 12, fixed arms member 14, and shiftable arm member 16. It is to be understood that more than a single shiftable arm member 16 may be provided, as desired.

Back plate member 12 has a foreside 20 and an opposed rear side 22. Proprietary or other attach points may be mounted to the rear side 22 for coupling of the rock picker attachment 10 to an exemplary skid steer implement 1500.

A rear directed end flange 24 is provided at either end of back plate member 12. Additionally, a rear directed bottom flange 26 is provided at the bottom margin of the back plate member 12.

The foreside 20 includes an upper support flange 28 and a spaced apart, generally parallel lower support flange 30, fixedly coupled to the foreside 20 at a respective edge 27 thereof. The flanges 28, 30 are generally planar, the plane thereof being preferably disposed transverse with respect to the back plate member 12. The flanges 28, 30 preferably forwardly directed with respect to the foreside 20 in an orthogonal relationship. Vertically aligned, spaced apart slots 32, 32a are defined in the respective flanges 28, 30.

Turning to the fixed arms member 14, the fixed arms member 14 preferably includes a pair of fixed arms 15a,b, the fixed arms 15a,b being of substantially similar construction and being spaced apart in a generally parallel disposition. It is to be understood that additional fixed arms 15 may be included as desired. Each of the fixed arms member 15a,b includes an arm member 34. The arm member 34 is preferably formed of an integral unitary device and includes a support portion 36 and rock engaging portion 38. The engaging portion 38 is preferably angled with respect to the support portion 36 at an included angle of greater than 90 degrees. The support portions 36 reside within the slots 32 and are held therein by suitable weldments at edge 37, of support portion 36 further secure each of the fixed arms member 14 to the back of plate 12.

The engaging portion 38 extends forward from the back plate member 12 and is angled downward therefrom and defines an angle 39 with an associated support portion 38 of greater than a right angle. Each of the engaging portions 38 of the fixed arms 15a,b has an angled end 40 having a lower face 41 that is defined generally perpendicular to the plane of the back plate member 12. A penetrator 42 is affixed preferably by welding to the lower face 41 of the angled end 40. The penetrator 42 extends forward of the forward margin 43 of the angled end 40. The penetrator 42 includes a pointed tip 44. The width of the penetrator 42 is greater than the width of engaging portion 38 such that the penetrator edge 43 extends beyond the side margin 41 of the engaging portion 38.

The shiftable arm member 16 is disposed generally in an opposed relationship with respect to the fixed arms member 14. Shifting the shiftable arm member 16 acts to increase or decrease a gap defined with respect to the fixed arms member 14. Shiftable arm member 16 includes an upright support member 50 and a shiftable arm member 52.

The upright support member 50 preferably includes parallel, spaced apart support members 54. Each of the spaced apart parallel support members 54 resides within a slot 32a, noted above, and is maintained in such disposition by suitable weldments. The parallel support members 54 each exhibit forward directed ear 56 disposed proximate upper margin 55 of the parallel support members 54. The ears 56 each have a bore 58 defined therein, the bores 58 of the [symbol] .

A single upright support member 60 is captured between the parallel support members 54, projecting upward from upper margins 55 and defines the upper margin of the upright support member 50. A bore (not shown) is defined in the single upright support member 60.

The third subcomponent of the rock picker attachment 10 is the shiftable arm member 16. The shiftable arm member 16 is preferably disposed centrally with respect to the spaced apart fixed arms 15a,b and above fixed arms 15a,b.

The shiftable arm member 16 includes an extending portion 70 that is preferably coupled angularly to a depending portion 72. Preferably, the extending portion 70 and the depending portion 72 are integrally formed. A bore (not shown) is defined in the proximal end of the extending portion 70 and is in registry with bore 58. A pin (not shown) may be passed through the bores 58 and the bore defined in the extending portion 70 to shiftably couple the extending portion 70 to the upright support member 50. A generally upward directed ear 74 is disposed on the upper margin 71 of the extending portion 70. The ear 74 has a bore (not shown) defined therein.

An actuator 76, preferably a hydraulic cylinder, is coupled between the single upright support member 60 and the ear 74. Such coupling spaces the hydraulic cylinder 76 apart from and generally parallel to the extendable portion 70. A shiftable fixed coupler 78 is coupled to the single upright support member 60 by means of a pin (not shown) disposed in a bore 80, the pin passing through a bore (not shown) defined in the single upright support member 60.

An extendable ram 82 is disposed at the distal end of the actuator 76. The ram 82 is coupled by means of a coupler having a bore 86 defined therein that is coupled to the ear 74. Preferably, a pin (not shown) is passed through the bore 86 and the bore (not shown) defined in the ear 74.

A strengthening gusset 88 is provided between the extending portion 70 and the depending portion 72 of the shiftable arm member 52. Depending portion 72 of the shiftable arm member 52 ends with a tapered face defining a point 92.

In operation, the fixed arms member 14 may be driven into the soil beneath a rock that is to be picked up. In such disposition, the shiftable arm member (or plural shiftable arm members) 16 is preferably opened to create the maximum spread of the jaws defined between the shiftable arm member 16 and the fixed arms member 14. Such initial disposition is attained by retracting the extendable ram 82. In such disposition, the extendable ram 82 may be extended. Such action causes the shiftable arm member 52 to rotate downward, closing the jaws and thereby diminishing the gap defined with the fixed arms member 14, to capture the rock between the shiftable arm member 16 and fixed arms member 14. Once captured, the rock picker attachment 10 may be rotated as indicated by the arrow 94 such that the rock may reside against the structure that is coupled to the foreside 20 of the back plate member 12 in a captured disposition and the rock may be elevated for removal.

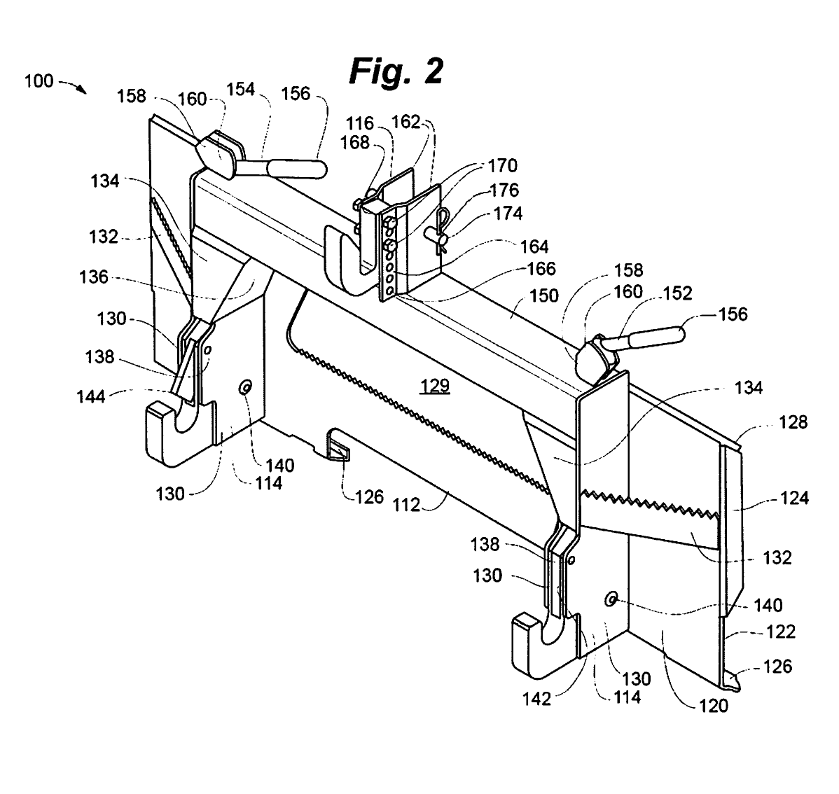

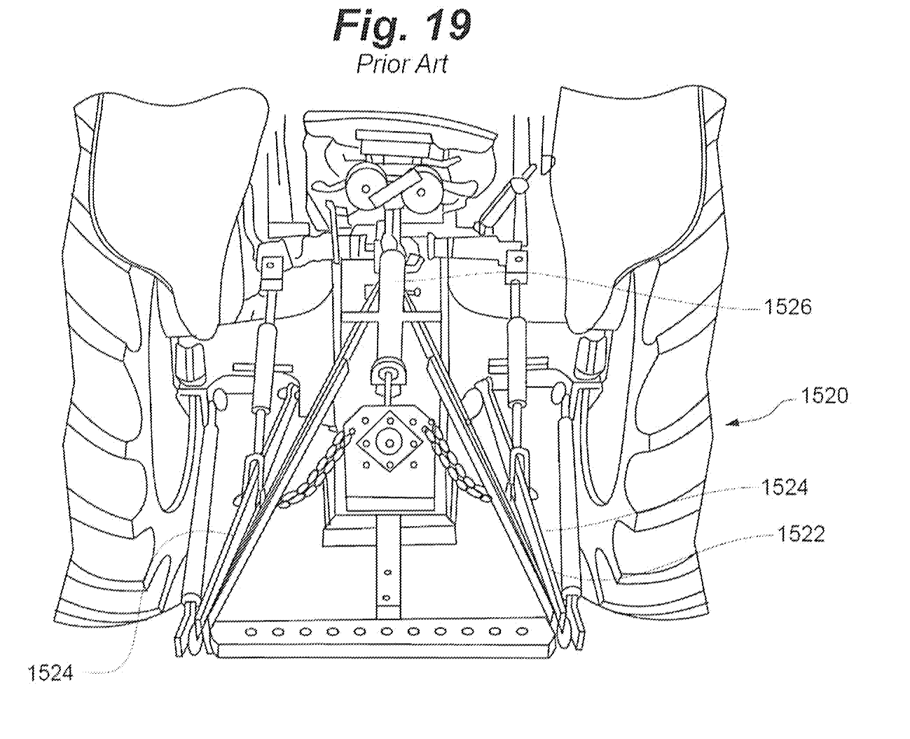

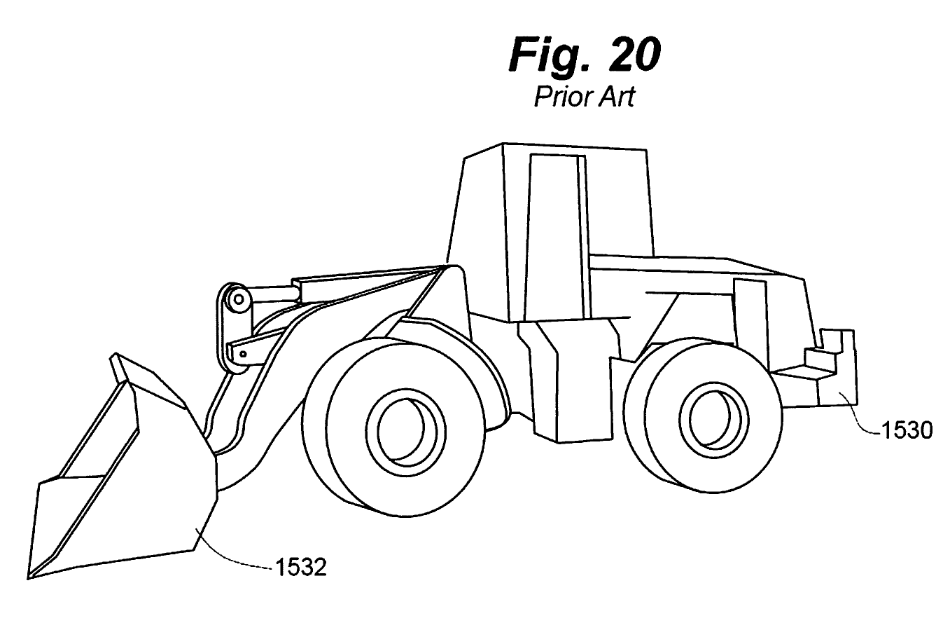

Referring now to FIG. 2, s second embodiment of the present invention comprising a 3-point skid steer adapter plate 100 is depicted. Three-point skid steer adapter plate 100 is designed to be coupled to an exemplary skid steer device 1500 as noted in prior art FIGS. 17 and 18. The 3-point skid steer adapter plate 100 is designed to quickly attach to an implement that is designed to be coupled to a 3-point hitch as indicated in prior art FIG. 19 in order to minimize the operator actions necessary co effect such attachment. Three-point skid steer adapter 100 includes three major subcomponents; back plate member 112, lower hook members 114 and upper hook member 116.

The back plate member 112 is designed similar to the back plate member 12 described with respect to FIG. 1. Accordingly, back plate member 112 includes a foreside 120 and a rear side 122. The rear side 122 may include attaching points for attaching the 3-point skid steer adapter 100 to a suitable skid steer implement 1500, as indicated in prior art FIGS. 17, 18. Back plate member 112 additionally includes a rear directed end flange 124 and a rear directed bottom flange 126. Additionally, back plate member 112 includes a depending top flange 128 and has a central opening 129 defined therein.

Turning to the second of the subcomponents of the 3-point skid steer adapter 100, lower hook members 114, each of the two spaced apart lower hook members 114 includes a pair of spaced apart side plates 130. The outer side plates 130 are supported by a support member 132 that extends from the back plate member 112 to the respective side plate 130. Facing gussets 134 and inner gussets 136 cooperate to provide additional support for the respective side plates 130. Pin bores 138, 140 are defined in each of the side plates 130.

There are two shiftable locking members 142, 144. The locking members 142, 144 are held in place by a respective pin (not shown) that is passed through the respective bores 138. The locking member 142 is shown in the retracted unlocked disposition while the locking member 144 is shown in the extended locking position. In such disposition, the locking member 144 is capable of capturing a pin adapted for coupling to lift arms 1524 of tractor 1520, as indicated above.

The third of the subcomponents of the 3-point skid steer adapter 100 is the upper hook member 116. The upper hook member 116 is capable of engaging a pin adapted for coupling to lupper arm 1526 of tractor 1520, as indicated above. The upper hook member 116 is supported on a cross-tube 150 that may be attached as by suitable weldments to the foreside 120 of the back plate member 112. Respective locking actuators 152, 154 are disposed on the upper margin of the cross-tube 150. The locking actuators 152, 154 each include a handle 156. The handle 156 is operably coupled to an over center device 158. A pin 160 that passes through the over center device 158 connects a depending coupler that is not shown but resides within the space defined between respective side plates 130, to the respective locking members 142, 144. It should be noted that the locking actuator 152, being coupled to locking member 142 is in the open, unlocked disposition. The locking actuator 154, being coupled to the locking member 144 is in the closed and locked disposition.

The upper hook member 116 includes two spaced apart side members 162. Each of the side members 162 includes a variable height hook coupler 164. The variable height hook coupler 164 includes a plurality of bores 166. A hook shank 168 is disposed between the side members 162 and coupled thereto by means of bolts 170 and a pin 174 that is disposed in a bore 176 that is defined in registry in each of the side members 162.

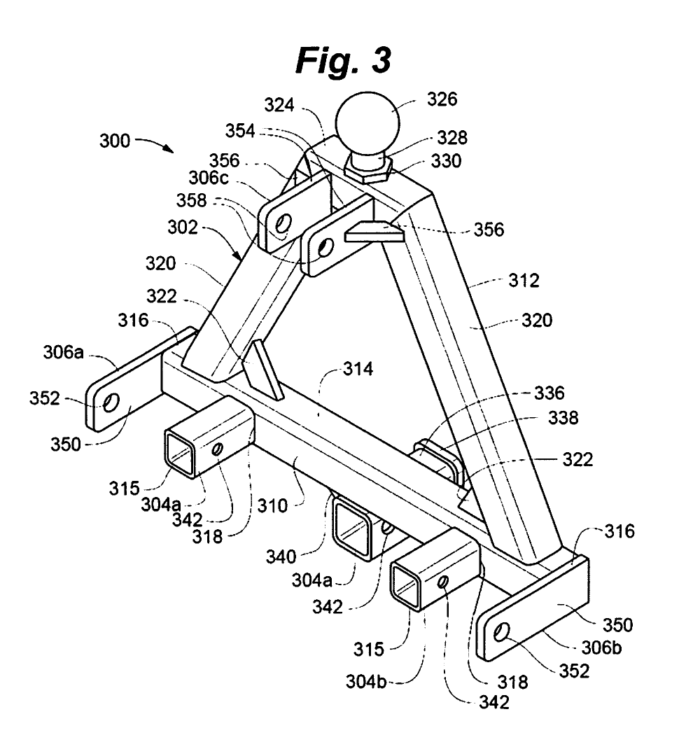

A third embodiment of the present invention is depicted in FIG. 3. The third embodiment is a 3-point hitch with a two inch receiver, shown generally at 300 in the depiction. Hitch 300 is designed to be coupled to a three-point hitch 1522 as depicted in prior art FIG. 19. Hitch 300 includes three major subcomponents; trapezoidal frame 302, three-point coupler 306, and receiver 304.

The trapezoidal frame 302 of hitch 300 includes a tractor side 310 and an opposed implement side 312. It is the tractor side 310 that is most readily viewed by the viewer of the depiction of FIG. 3. Trapezoidal frame 302 includes a base tube 314. The two ends of the base tube 314 are capped with a tube end 316. A generally rectangular auxiliary receiver aperture 318 is defined in the tractor side 310 of the base tube 314. Spaced apart side tubes 320 extend upward from the upper margins of the base tube 314 and angling inward towards each other as the side tubes 320 rise. A supporting gusset 322 extends from the upper margin of the base tube 314 to the inner margin of the respective side tubes 320.

A relatively short top tube 324 extends between the upper margins of the respective side tubes 320. Top tube 324 has a generally vertical bore (not shown) defined therethrough by which a conventional ball hitch 326 may be coupled to the top tube 324. Ball hitch 326 has a threaded shank 328 that extends well through the top tube 324. A lock nut 330 and a second nut threaded onto the threaded shank 328 at the underside of the top tube 324 suffice to affix the ball hitch 326 to the top tube 324.

The second subcomponent of the hitch 300 is the two inch receiver 304. The receiver 304 has a tubular body 336 that defines substantially a two inch square interior aperture for receiving a two inch shank of hitch. An entrance surround 338 extends peripheral to the inlet mouth of the tubular body 336 on the implement side 312 of the hitch 300. Pin bores 342 that are in registry and extend through the side walls of the tubular body 336 are included. It is by means of a pin inserted through the pin bores 342 and through a bore defined in the shank of a receiver hitch that is inserted within the receiver 304 is held in place therein. A generally triangular pair of gussets 340 that extend between the underside of the base tube 314 and the side walls of the tubular body 336 act to strengthen the connection between the tubular body 336 and the base tube 314.

Auxiliary receivers 304a, 304b are inserted in the receiver apertures 318 defined within the base tube 314. It should be noted that the tube 315 that comprises the auxiliary receivers 304a, 304b has generally smaller side dimensions than that of the tubular body 336. Additionally, the auxiliary receivers 304 may be passed through the tubular body 336 and open substantially flush with the implement side 312 of the tubular body 336. Pin bores 342 are defined the side walls of the auxiliary receivers 304a, 304b.

The third subcomponent of the hitch 300 is the three-point couplers 306. With respect to the two three-point couplers 306a and 306b which define the two lower spaced apart three-point couplers, an elongate end plate 350 is fixedly coupled to the end margins of the base tube 314. The distal end of the respective plates 350 extends in the tractor side 310 direction. Each respective plate 350 has a pin bore 352 defined therein.

The upper single coupler 306c is defined by two spaced apart plates 354. Each of the two plates 354 is fixedly coupled to the top tube 324 and extends from the tractor side 310 thereof. A strengthening gusset 356 extends between the outer side margin of the respective plates 354 and the top tube 324. Pin bores 358 are defined in the respective plates 354.

In operation, the lift arms 1524 of the prior art three-point hitch 1522 (see prior art FIG. 19) may be coupled to the respective three-point coupler 306a, 306b by means of a pin inserted through the respective pin bores 352 and held in place with a conventional clinch pin. The centered link 1526 of the three-point hitch 1522 may be coupled to the upper three-point coupler 306c by means of a pin passed through the bores 358 and an eyelet disposed at the end of the upper link 1526.

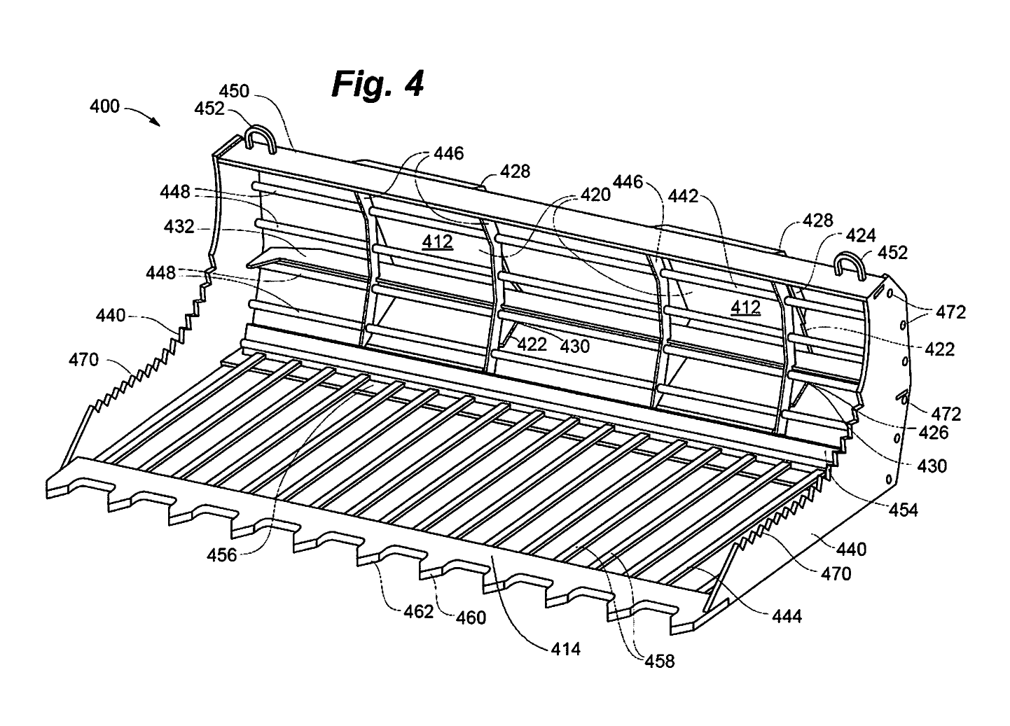

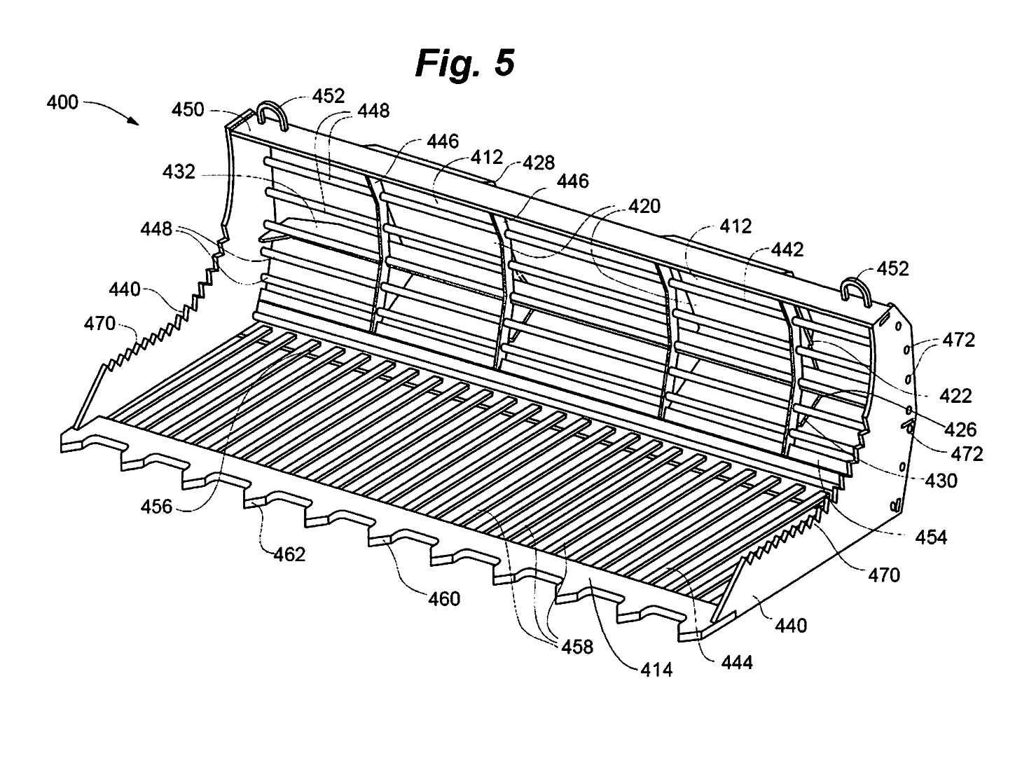

Turning to the embodiments of FIGS. 4 and 5, the embodiments of FIGS. 4 and 5 may be taken together as each of them relates to a utility rock bucket 400, the bucket 400 of FIG. 4 being 70 inches in width and the rock bucket 400 of FIG. 5 being 75 inches in width. All of the features of FIGS. 4 and 5 remain the same.

The rock bucket 400 of FIGS. 4 and 5 includes two major subcomponents; back plate member 412 and bucket member 414. It should be noted that the back plate member 412 of FIG. 4 is distinct from back plate member 12 of the device of FIG. 1, the back plate member 412 of the FIG. 4 device being in two spaced apart portions.

Back plate member 412 includes a foreside 420 and an opposed rear side 422. It is to the rear side 422 that the devices necessary for coupling to a skid steer 1500 are included. Each of the portions of the back plate member 412 includes a rear directed end flange 424, a rear directed bottom flange 426, and a upper support flange 428. A right angle member 430 extends from the back plate member 412 to the lower portion of the bucket member 414.

A transverse strengthening member 432 extends from the right angle defined between the back plate member 412 and the right angle member 430 and is further coupled to the bucket member 414.

The second subcomponent of the rock bucket 400 is the bucket member 414. Bucket member 414 includes two spaced apart end plates 440, a back member 442, and an insertion member 444.

The end plate 440 is designed to fixedly couple, in part, the back member 442 and the insertion member 444. Accordingly, the end plate 440 extends along the end margin of both the back member 442 and the insertion member 444. The end plate 440 has an upper margin along which a plurality of serrations 470 are defined. A plurality of bar apertures 472 are defined along the portion of the end plate 440 that is adjacent to the back member 442.

The back member 442 is comprised in part of a plurality of cross bars 448 that extend between the two end plates 440 and are coupled thereto by insertion in respective bar apertures 472. The cross bars 448 are further supported by a plurality of strakes 446 that depend from a top plate 450. The top plate 450 extends between the two end plates 440. A pair of upward directed shackles 452 are disposed proximate the respective ends of the top plate 450. The strakes 446 terminate at their lower margins with a coupling to a bottom plate 454. The bottom plate 454 is substantially co-extensive with the top plate 450 and extends between the two end plates 440.

The insertion member 444 of the bucket member 414 extends from the back member 442. A transverse plate 456 that is disposed with a side margin adjacent a side margin of the bottom plate 454 extends between the two end plates 440. A plurality of bars 458 that are disposed transverse to the plate 456 extend toward the distal margin of the insertion member 444. Adjacent bars 458 are spaced apart so that dirt and debris that is captured along with a rock may readily fall through the insertion member 444. The distal end of the transverse bars 458 terminate by being coupled to an insertion element 460. The insertion element 460 extends between the two end plates 440. The leading edge of the insertion element 460 is capped with a plurality of spaced apart points 462 to facilitate insertion in soil underlying a rock to picked.

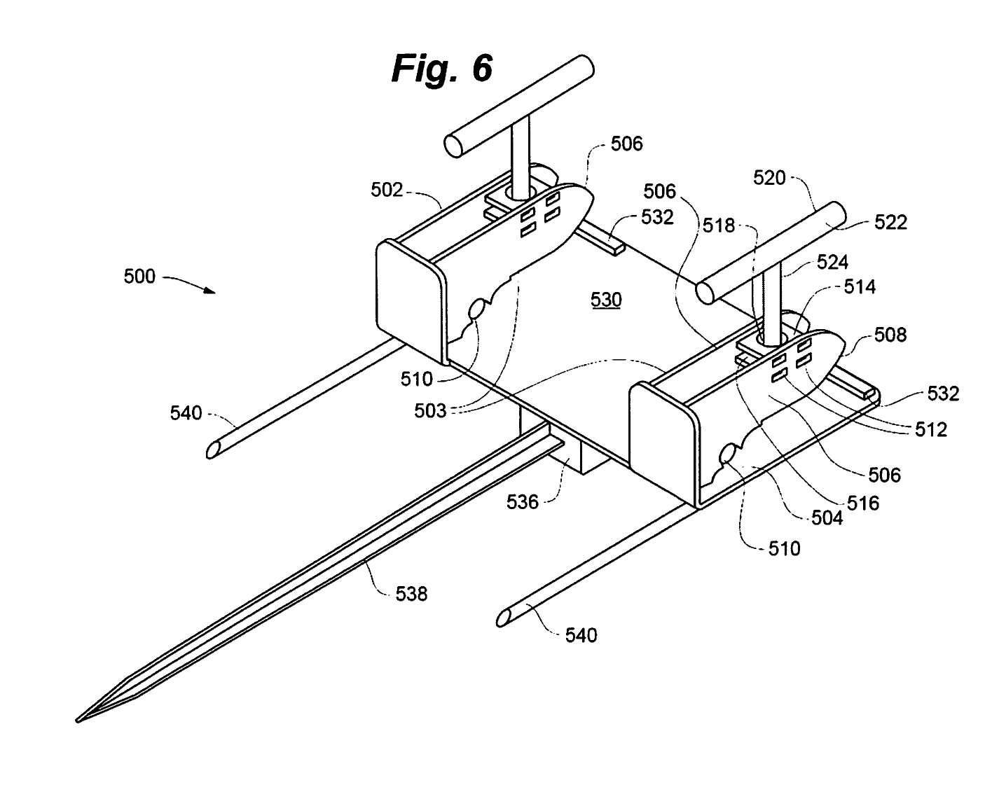

Turning to the embodiment depicted in FIG. 6, a bale spear attachment is shown generally at 500. Bale spear attachment 500 includes two major subcomponents, attaching device 502 and spear device 504. It should be noted that bale spear attachment 500 is meant to be clamped to the lower portion of a bucket 1502 as depicted in prior art FIGS. 17 and 18 and the bucket 1532 as depicted in prior art FIG. 20.

The attaching device 502 includes two spaced apart clamping units 503 that are virtually identical in construction. Each of the clamping units 503 includes a pair of spaced apart side members 506. The spaced part side members 506 define a tapered inlet for capturing the leading edge of the bucket 1502, 1532 of an implement on which the bale spear attachment 500 is to be affixed. A cross tube 510 extends between the respective side members 506 of each of the clamping units 503. A plurality of coupling slots 512 are defined through each of the respective side members 506. An upper spacing plate 514 and a lower spacing plate 516 extend between the side members 506 of the respective clamping units 503. Each of the upper spacing plates 514 and lower spacing plates 516 include outwardly directed tabs that may be inserted in coupling slots 512 and welded into position therein. The lower spacing plate 516 has a threaded bore (not shown) that is in registry with the bore 518 defined in the upper spacing plate 514.

Each of the clamping units 503 includes a t-clamp 520. The t-clamp 520 includes a handle 522 and a transverse, depending threaded shank 524. The threaded shank 524 is threadedly engaged with the threaded bore (not shown) defined in the lower spacing plate 516.

The spear device 504 includes a plate 530 to which the respective clamping units 503 are coupled by means of upward directed tabs 532. The clamping units 503 are spaced apart from the upper margin of the plate 530 to define a space for insertion of the bottom of an implement bucket. Relatively small tabs 532 may be disposed at an edge of the plate 530 for assisting and retaining the implement bucket when coupled to the bale spear attachment 500. A block support 536 is fixedly coupled to the underside of the plate 530. A primary spear 538 extends outward from the block support 536. Secondary spears 540 are fixedly coupled to the underside of the plate 530 and flank the primary spear 538.

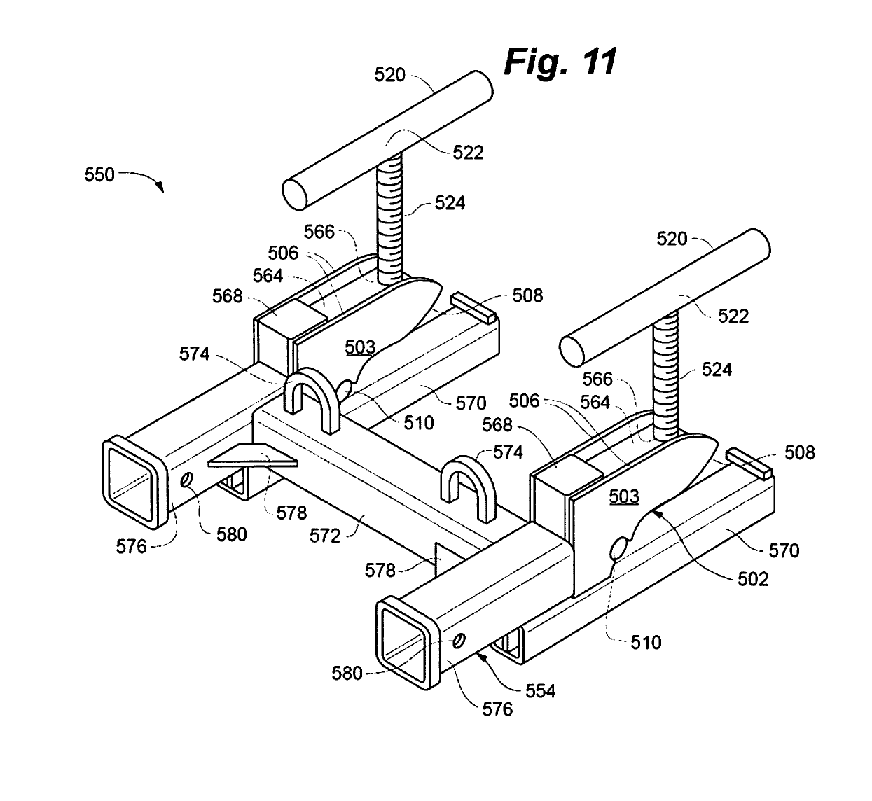

Turning to FIG. 11, an embodiment of the present invention is depicted having much the same attaching device as the attaching device 502 discussed with regard to the bale spear attachment 500. The attachment depicted in FIG. 11 is a heavy duty hitch receiver clamp shown generally at 550. Hitch receiver clamp 550 includes two subcomponents; attaching device 502 and receiver device 554. The hitch receiver clamp 550 includes two clamping units 503 having side members 506, a tapered inlet 508, a cross tube 510, as noted in the description of FIG. 6. A spacing member 564 is disposed between each of the respective side members 506 comprising a respective clamping unit 503. A threaded bore 566 is defined through the spacing member 564. A tube 568 is disposed adjacent to the spacing member 564 and extends between the respective side members 506.

Each of the respective clamping units 503 includes a t-clamp 520 having a handle 522 and a transverse, depending threaded shank 524. The threaded shank 524 is threadedly engaged with the threaded bore 566.

Each of the clamping units 503 includes a tube 570 underlying the respective side members 506.

The receiver device 554 of the hitch receiver clamp 550 includes a cross tube 572 having a pair of coupling eyes 574 affixed to the upper margin thereof. A pair of spaced apart receiver tubes 576 are disposed at respective ends of the cross tube 572. The receiver tubes 576 are strengthened by a gusset 578 that extends between the side margin of the receiver tubes 576 and the leading edge of the cross tube 572. A pin bore 580 extends between the respective side elements of the receiver tube 576. An inlet surround is disposed at the end of the respective receiver tubes 576.

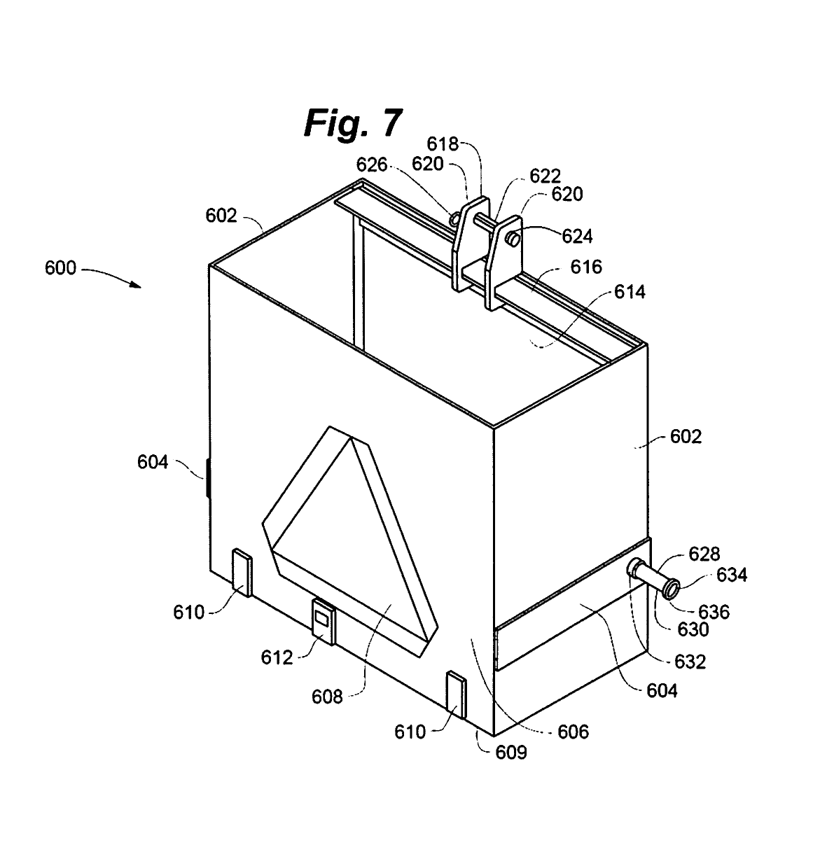

A further embodiment of the present invention is depicted in FIG. 7. Embodiment of FIG. 7 is a ballast box shown generally at 600. The ballast box 600 is adapted to be coupled to a three-point hitch 1522 as depicted in prior art FIG. 19. The ballast box 600 is generally rectangular in shape having a top opening for insertion of ballast. Additionally, the bottom 609 may be openable to readily discharge the ballast contained within the ballast box 600.

The ballast box 600 includes two opposed sides 602 each of the respective sides 602 includes a plate 604, the plate 604 extending from the respective side margins of the side 602.

A front 606 and opposed back 614 are coupled to the respective sides 602. An on-road reflector 608 may be affixed to the front 606. The bottom 609 may be coupled to either the front 606 or the back 614 by means of hinges 610. A latch 612 is depicted between the respective hinges 610. Preferably, the hinges 610 couple the bottom 609 to the back 614 and the latch 612 holds the bottom 609 in the closed disposition.

A cross plate 616 extends between the opposed sides 602 and fixedly coupled to the back 614. The cross plate 616 supports the upper three-point hitch 618.

The upper three-point hitch 618 has two spaced apart side plates 620 and a pin 622 residing in respective pin bores 624 defined in the respective side plates 620. The pin 622 is retained in place by a suitable keeper 626.

A pair of side three-point hitches 628 extend outwardly from the respective sides 602. Each of the side three-point hitches 628 includes a shank 630 and a coupler 632 for coupling the shank 630 to the respective side 602. A transverse bore 634 is defined through the shank 630 proximate the distal end of the shanks 630. A keeper 636 may be removably disposed within the transverse bore 634.

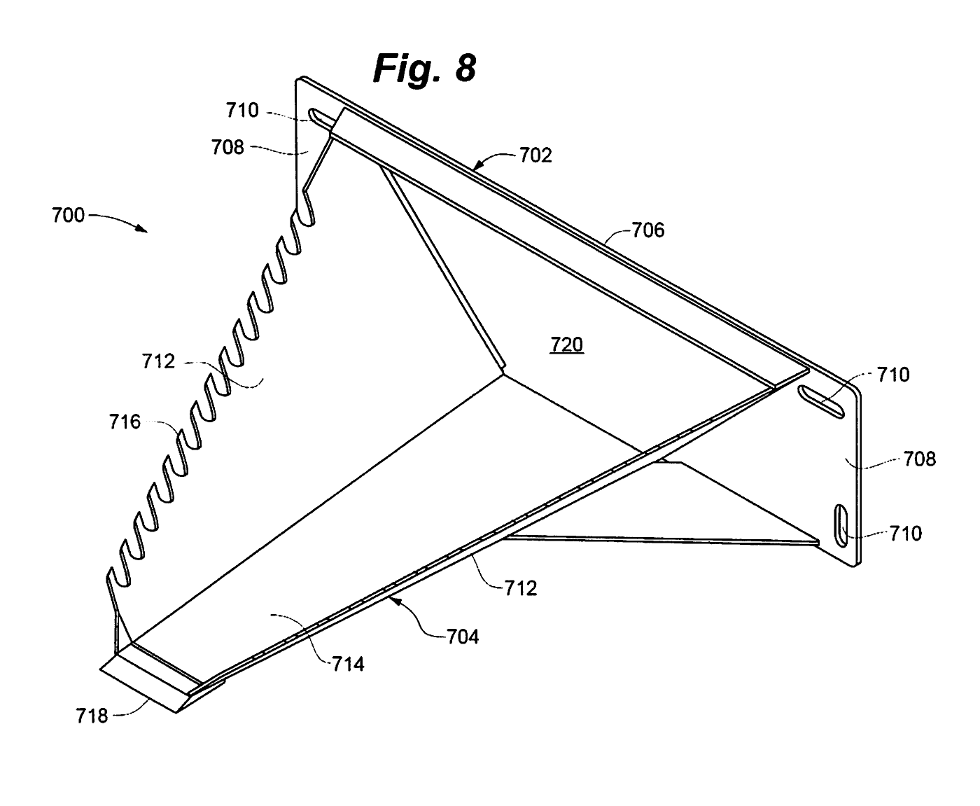

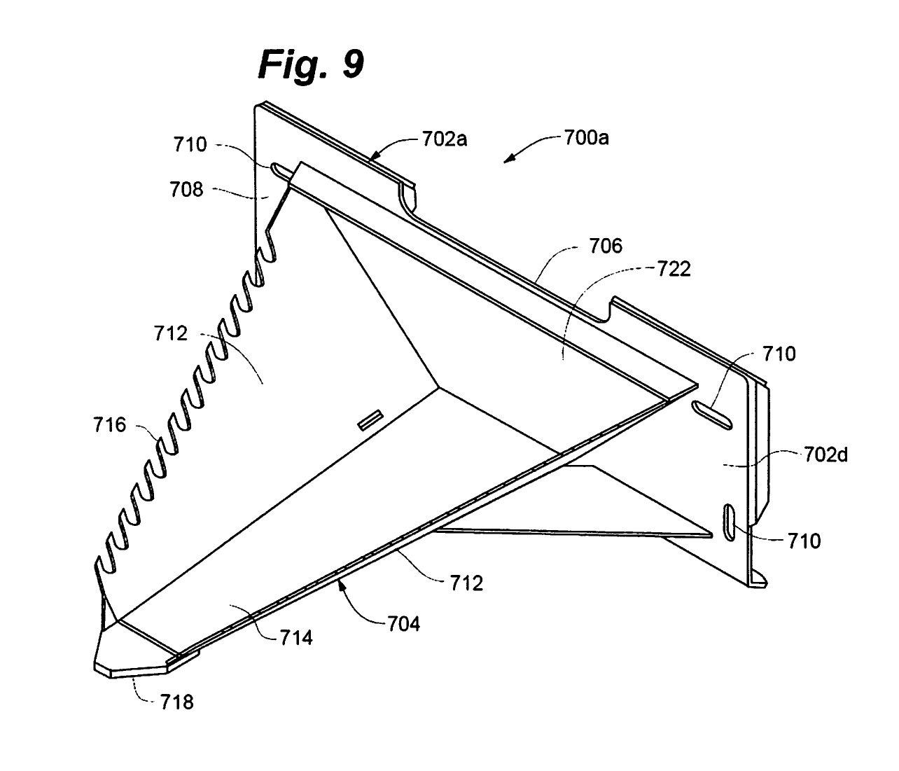

FIGS. 8 and 9 depict a further embodiment of the present invention. The embodiments of the FIGS. 8 and 9 are virtually identical with the exception that the embodiment of FIG. 8 has an aperture 720 for being bolted on, whereas the embodiment of FIG. 9, an aperture closure 722 is included, the embodiment of FIG. 9 being adapted for coupling to a skid steer implement 1500. The embodiment of FIGS. 8 and 9 is a bolt on root ripper shown generally at 700. Root ripper 700 includes two major subcomponents; backing member 702 and ripping member 704. Backing member 702 includes a upper cross bar 706 and a depending integral end piece 708. A plurality of slots 710 are defined in the backing member 702. In the embodiment of FIG. 8, an aperture 720 is defined in the backing member 702.

The ripping member 704 includes a pair of spaced apart angled side plates 712 coupled at their lower margins to a bottom plate 714. The upper margin of the angled side plates 712 include a plurality rearward directed teeth 716. A replaceable insertion device 718 is disposed at the distal end of the bottom plate 714.

Referring to the nearly identical embodiment of FIG. 9, the bolt on root ripper 700 includes a backing member 702a that is adapted for coupling to a skid steer device 1500. Accordingly, the attaching devices for attaching to the skid steer device 1500 are affixed to the rear margin of backing member 702a.

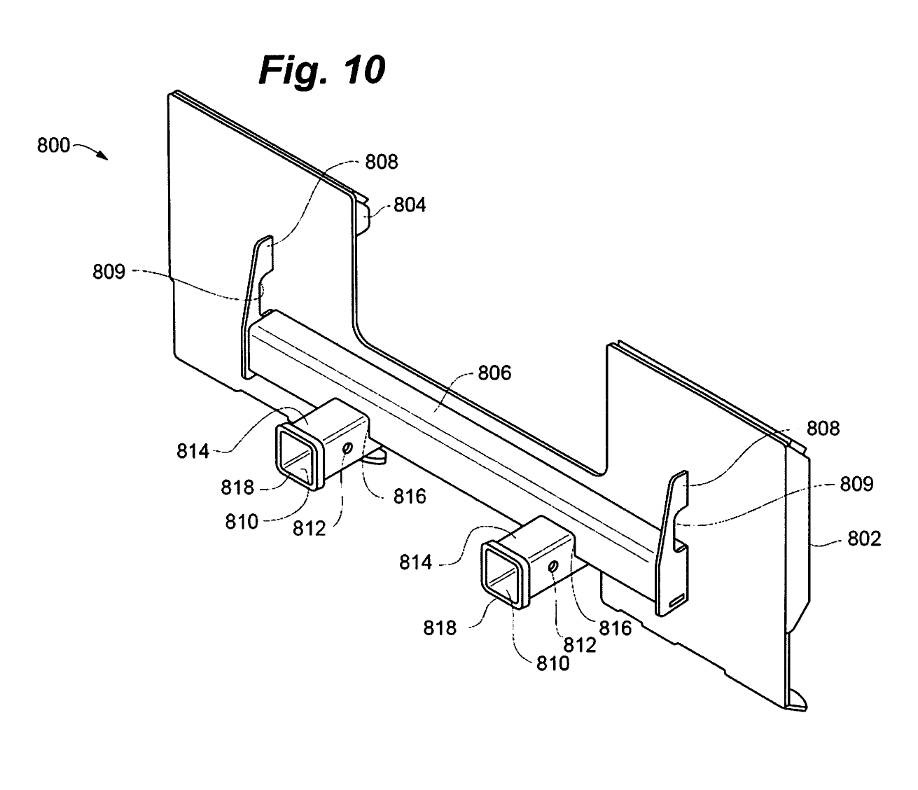

The embodiment of FIG. 10 is a dual hitch receiver plate shown generally at 800 in the depiction. Dual hitch receiver plate 800 is adapted for coupling to a skid steer 1500 as depicted in prior art FIGS. 17 and 18. Accordingly, the coupling devices for readily coupling to the skid steer device 1500 are affixed to the rear margin of plate 802 as indicated at 804 in the depiction.

A cross tube 806 is fixedly coupled to the plate 802. The cross tube 806 is capped at either end margin by slotted end pieces 808. Each of the slotted end pieces 808 includes a slot 809 defined therein. A pair of hitch receivers 810 are fixedly coupled to the cross tube 806. The spaced apart hitch receivers 810 each include pin bores 812 defined in the side margin of the respective tube bodies 814. A notch 816 for each of the hitch receivers 810 is defined in the cross tube 806 and the tube body 814 may be welded therein. Each of the respective hitch receivers 810 includes an inlet surround 818 at the inlet and of the tube body 814.

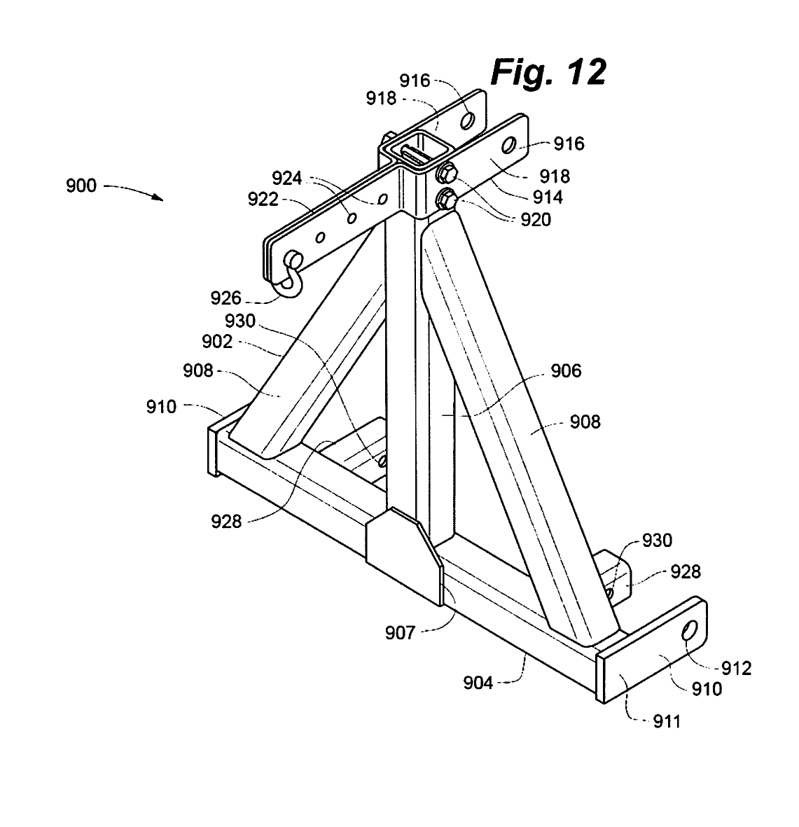

A log skidder attachment is depicted in FIG. 12. The log skidder attachment is shown generally at 900. The log skidder attachment 900 is adapted to be coupled to three-point hitch 1522 of a tractor 1520, as depicted in prior art FIG. 19. The log skidder attachment 900 includes a frame 902.

The frame 902 includes a base frame 904 and a centrally disposed upright tube 906. A gusset 907 may be employed to improve the strength of the coupling between the base tube 904 and the upright tube 906. Angled side tubes 908 extend from proximate the outer margin of the base tube 904 to near the upper margin of the upright tube 906.

A respective lower three-point hitch 910 is disposed at either opposed end of base tube 904 by means of a plate 911, plate 911 being disposed to cap a respective end of the base tube 904. The plate 911 is directed toward the implement and includes a pin bore 912 for receiving a pin coupled to a respective lift arm 1524, as noted in FIG. 19.

Upper three-point hitch 914 is coupled to the upper margin of the upright tube 906. The upper three-point hitch 914 is formed by two opposed mirror image straps 918. A first end of the straps 918 includes a pin bore 916 for receiving a pin, the pin for coupling the upper link 1526 of the three-point hitch 1522, as noted in prior art FIG. 19. The straps 918 are bolted to the upright tube 906 by means of bolts 920.

A skidder extension 922 is comprised of two adjacent portions of the straps 918. The skidder extension 922 includes a plurality of spaced apart bores and includes a clevis 926 that may be selectably disposed in a selected one of the bores 924.

A pair of rearward directed tubes 928 are fixedly coupled to the base tube 904. Each of the tubes 928 includes a bore 930 extending through the side margins of the tubes 928.

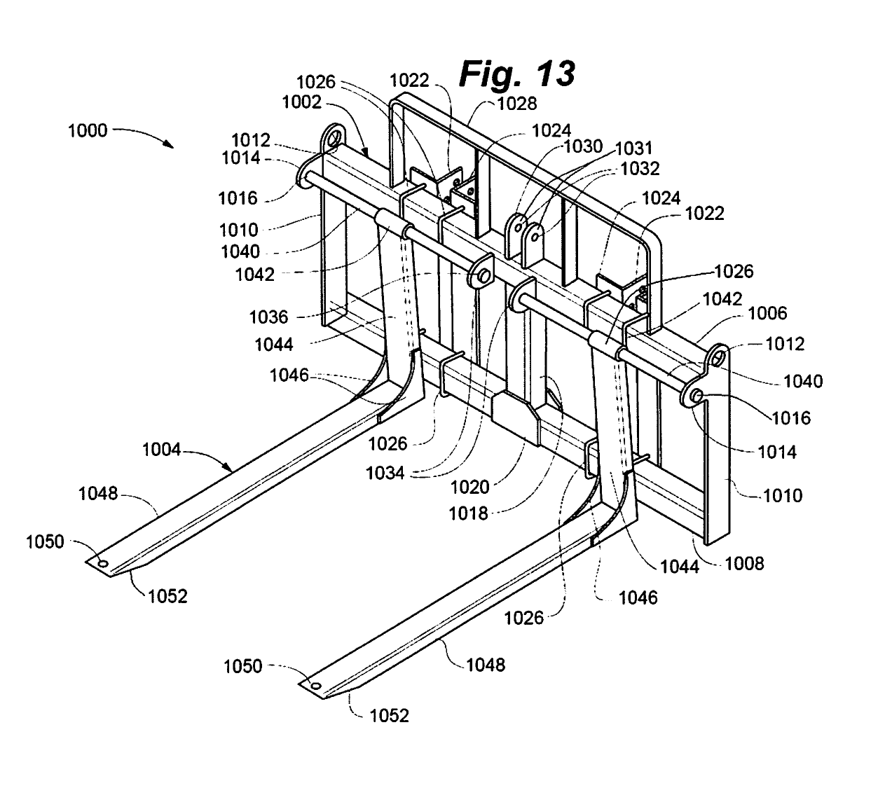

Turning to FIG. 13, a pallet forks attachment for a front end loader is generally shown at 1000 in the depiction. The pallet forks 1000 of the instant embodiment are designed for use with a front end loader 1530 as depicted in prior art FIG. 20. The bucket 1532 is removed from the front end loader 1530 and the pallet forks 1000 substituted in its place. The pallet forks 1000 include two subcomponents; frame 1002 and forks 1004.

The frame 1002 includes spaced apart upper transverse tubes 1006 and lower transverse tube 1008. A pair of spaced apart opposed end plates 1010 cap the respective ends of the upper transverse tube 1006 and the lower transverse tube 1008. An eyelet 1012 is defined proximate the upper margin of the respective end plates 1010. Additionally, an ear 1014 is formed on the respective end plates 1010. Each respective ear 1014 has a bore 1016 defined therein.

A center upright 1018 extends between the upper transverse tube 1006 and the lower transverse tube 1008. A gusset 20 may be affixed at the juncture of the center upright 18 and lower transverse tube 1008.

Suitable coupling devices 1022 extend rearward from the frame 1002 for coupling to the front end loader 1530. The coupling devices 1022 are preferably made of angle iron 1024 and are held in place by a plurality of U-bolts 1026.

A guard 1028 is preferably affixed to the top margin of the upper transverse tube 1006.

A central coupler 1030 is disposed at the top margin of the upper transverse tube 1006. The coupler 1030 is formed by two spaced apart ears 1031, each respective ear 1031 having a coupler bore 1032 defined therein.

A pair of ears 1034 are disposed on the forward side margin of the upper transverse tube 1006. Each respective ear 1034 has a bore 1036 defined therein.

The second subcomponent of the pallet forks 1000 are the forks 1004. A support rod 1040 extends between a respective ear 1014 and a respective ear 1034. The support rod 1040 is supported in the respective bores 1016 and 1036. A tubular coupler 1042 is slidably disposed on each of the support rods 1040. A depending fork arm 1044 is fixedly coupled to each of the respective tubular shiftable couplers 1042. The depending fork arm 1044 is fixedly coupled to a generally orthogonally disposed extending fork arm 1048. A pair of gussets 1046 may be disposed at the intersecting coupling of the respective depending fork arm 1044 and the associated extending fork arm 1048.

The distal end of the extending fork arm 1048 is defined by a generally transverse beveled edge. A transverse bore 1050 is defined through each of the extending fork arms 1048 proximate the distal end thereof.

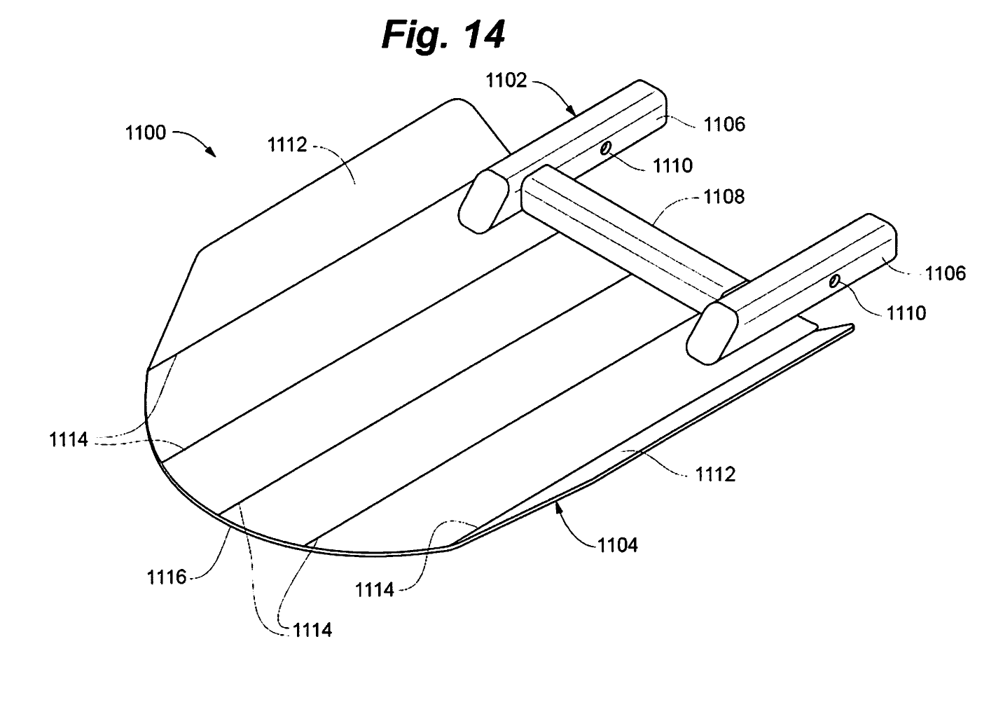

A further embodiment of the present invention is a quick spade attachment 1100 being depicted in FIG. 14. Quick spade attachment 1100 is adapted to be supported by and coupled to a device such as the dual hitch receiver plate 800 depicted in FIG. 10.

Quick spade attachment 1100 includes two major subcomponents; coupler 1102 and blade 1104. Coupler 1102 is comprised of two spaced apart tubes 1106 designed to be received within a receiver hitch. The tubes 1106 are spaced apart by means of a cross tube 1008. The cross tube 1008 is fixedly coupled to each of the respective tubes 1106 and to the upper surface of the blade 1104. Each of the tubes 1106 has a pair of pin bores 1110 defined therethrough.

The blade 1104 is preferably formed of a single sheet of metal. The shape of the blade 1104 is defined by suitable bends in the material forming the blade 1104. The blade 1104 has upturned sides 1112 and a plurality of bends 1114 define a generally curving blade bottom portion. The blade 1104 preferably has a curved leading edge 1116.

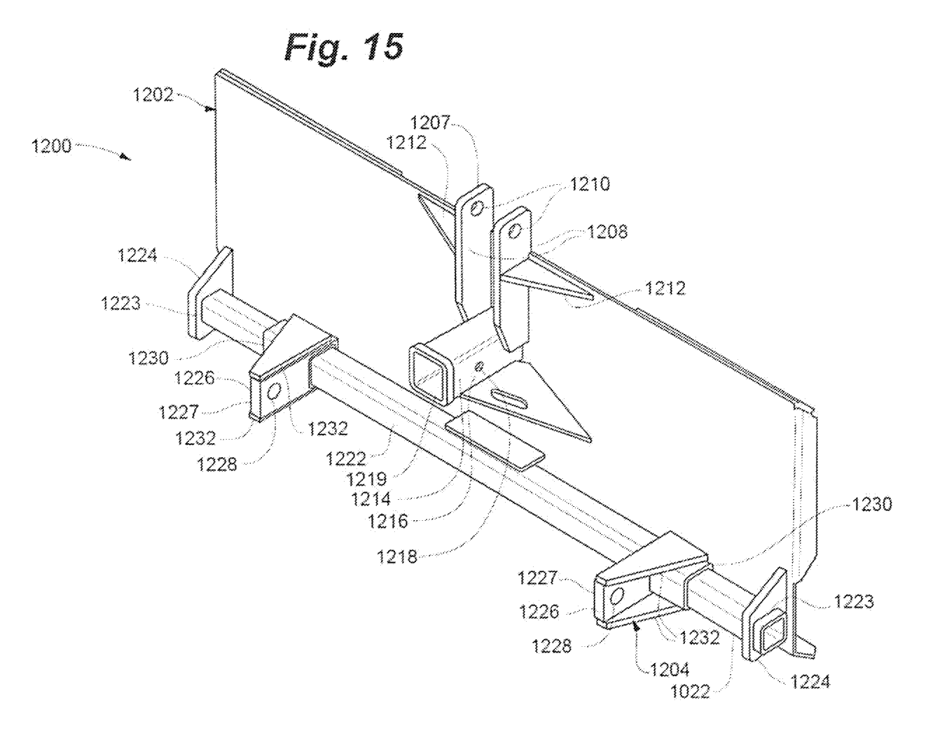

The embodiment of FIG. 15 is a skid steer three-point attachment shown generally at 1200. The skid steer three-point attachment 1200 is designed to be an interface between a skid steer 1500 as depicted in prior art FIGS. 17 and 18 and an implement having a three-point hitch. The three-point attachment 1200 has major subcomponents of mounting plate 1202 and three-point coupling devices 1204. As has been noted previously, the mounting plate 1202 has coupling devices mounted on its rear face for coupling to the skid steer devices 1500. The three-point coupling devices 1204 include an upper three-point coupler 1207.

Upper three-point coupler 1207 is defined by two spaced apart straps 1208 that are welded to the front face of the mounting plate 1202. Each of the straps 1208 has a pin bore 1210 defined therethrough for receiving a pin for coupling a three-point attachment device thereto. A pair of opposed gussets 1212 may extend between the mounting plate 1202 and the side margins of the respective straps 1208.

A receiver hitch 1214 may be disposed beneath the upper three-point coupler 1207. The receiver hitch 1214 is comprised of a tube 1216. The tube 1216 has a pair of pin bores 1218 extending side-to-side therethrough. An inlet surround 1219 is disposed at the tube 1216 inlet. A gusset 20 may be fixedly coupled to the underside margin of the tube 1216.

A transverse tube 1222 is disposed proximate the lower margin of the mounting plate 1202. The length of the transverse tube 1222 is substantially co-extension with the width dimension of the mounting plate 1202. The transverse tube 1222 is captured within apertures 1223 defined in a pair of end supports 1224 that are disposed proximate the end margin of the transverse tube 1222. Each of the end supports 1224 is fixedly coupled to the mounting plate 1202.

A pair of lower three-point coupling devices 1226 are affixed to the transverse tube 1222. A tube member 1230 is slid over the transverse tube 1222 and fixedly coupled thereto. A coupling plate 1227 is welded to tube member 1230. A pair of gussets 1232 are fixedly coupled to the tube member 1230 and the upper and lower margins of the coupling plate 1227. A pin bore 1228 is defined through the coupling plate 1227.

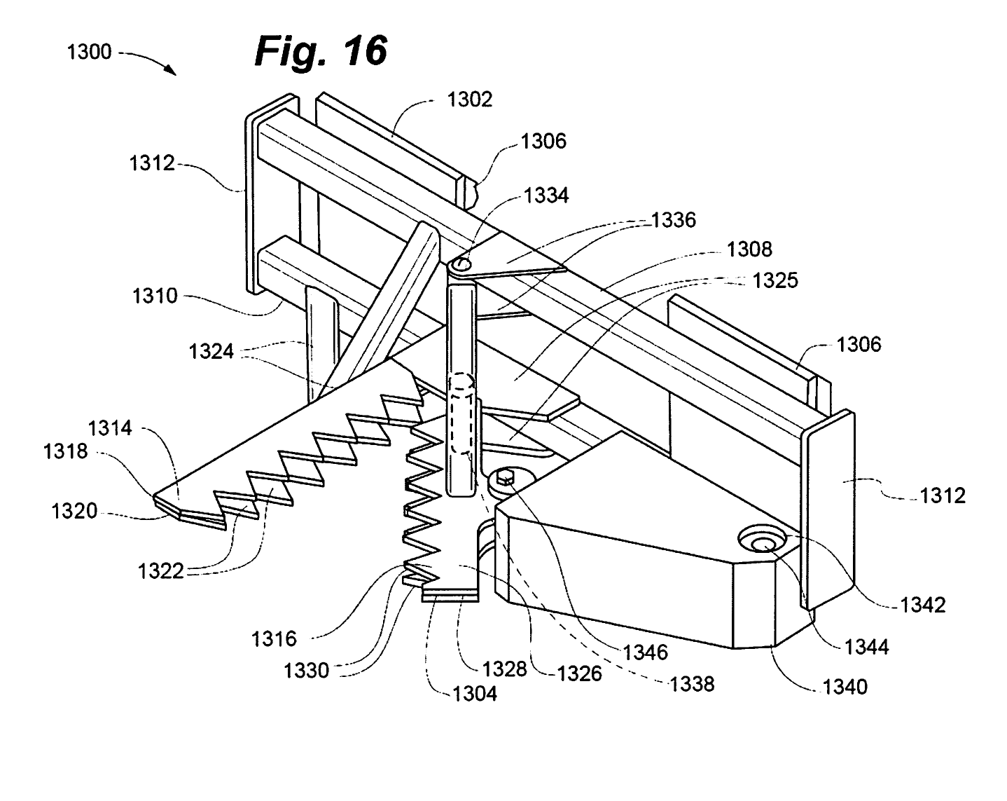

The final embodiment of the present invention is depicted in FIG. 16. The embodiment of FIG. 16 is a grapple tree puller as depicted generally at 1300. Grapple tree puller 1300 has major subcomponents of attaching plate 1302 and grapple device 1304. As previously noted, attaching devices for coupling the grapple tree puller 1300 to a skid steer implement 1500 are in part depicted at 1306 and are disposed on the rear face of the attaching plate 1302.

The grapple device 1304 includes an upper transverse tube 1308 and a lower transverse tube 1310. The upper transverse tube 1308 and the lower transverse 1310 are each affixed as by welding to the attaching plate 1302. A pair of end plates 1312 cap the respective ends of the respective upper transverse tube 1308 and lower transverse tube 1310.

The grapple tree puller 1300 further includes a fixed puller arm 1314 and a shiftable puller arm 1316.

The fixed puller arm 1314 includes an upper plate 1318 and a lower plate 1320 affixed thereto. Each of the upper plate 1318 and lower plate 1320 have inward directed teeth 1322 defined thereon. Fixed angled supports 1324 are coupled to the respective upper plate 1318 and lower plate 1320. The proximal end of the upper plate 1318 and lower plate 1320 are captured between a pair of spaced apart gussets 1325.

The shiftable puller arm 1316 includes an upper plate 1326 and a lower plate 1328. The respective upper plate 1326 and lower plate 1328 have inward directed teeth 1330 defined thereon. A shiftable angled support is fixedly coupled to the upper plate 1326 at a first end and shiftably coupled to a hinge 1334 at a second end. The hinge 1334 is formed by a pair of ears 1336 that are fixedly coupled to the upper transverse tube 1308. A lower hinge 1338 is defined through the plates defining the gusset 1325 to shiftably couple the upper plate 1326 and lower plate 1328 to gusset 1325.

A ram enclosure 1340 encloses and protects a ram 1342. Preferably, the ram 1342 is comprised of a hydraulic cylinder. The ram 1342 is coupled at a first hinge 1344 to the lower transverse tube 1310. The ram 1342 is coupled at a second end to the shiftable upper and lower plates 1326 and 1328 by means of hinge 1346.

In operation, a skid steer device 1500 mounting the grapple tree puller 1300 is advanced to position a tree trunk between the jaws defined by the upper and lower plates 1318, 1320 and the upper and lower plates 1326, 1328. The ram 1342 then extends shifting the shiftable puller arm 1316 toward the fixed puller arm 1314 and thereby capturing the trunk of the tree therebetween and holding it in place by means of teeth 22, 30. The skid steer 1500 then may be reversed pulling the captured tree trunk with it.

The foregoing descriptions present numerous specific details that provide a thorough understanding of various embodiments of the invention. It will be apparent to one skilled in the art that various embodiments, having been disclosed herein, may be practiced without some or all of these specific details. In other instances, components as are known to those of ordinary skill in the art have not been described in detail herein in order to avoid unnecessarily obscuring the present invention. It is to be understood that even though numerous characteristics and advantages of various embodiments are set forth in the foregoing description, together with details of the structure and function of various embodiments, this disclosure is illustrative only. Other embodiments may be constructed that nevertheless employ the principles and spirit of the present invention. Accordingly, this application is intended to cover any adaptations or variations of the invention.

For purposes of interpreting the claims for the present invention, it is expressly intended that the provisions of 35 U.S.C. §112(f) are not to be invoked unless the specific terms “means for” or “step for” are recited in a claim.

1. An implement attachment, being a rock picker attachment, comprising:
a back plate member;
a fixed arms member, the fixed arms member being fixedly coupled to the back plate member; and
a shiftable arm member, the shiftable arm member being operably, shiftably coupled to the back plate member and being shiftable relative to the fixed arms member to define a selectively variable gap therebetween.

2. The implement attachment of claim 1, the back plate member having a pair of generally parallel disposed flanges fixedly coupled thereto at a respective flange edge thereof to a foreside of the back plate member and being forwardly directed with respect to the back plate member foreside.

3. The implement attachment of claim 2, the pair of generally parallel disposed flanges, each flange having a first and a second pair of spaced apart slots defined therein, a respective slot defined in a first of the pair of respective flanges being vertically aligned with a respective slot defined in a second of the pair of respective flanges.

4. The implement attachment of claim 3, a first of a pair of upright support members being supported in a pair of the vertically aligned slots defined in the respective first and second flanges and a second of the pair of upright support members being supported in a second pair of the vertically aligned slots defined in the respective first and second flanges.

5. The implement attachment of claim 1, the fixed arms member including at least a pair of spaced apart, generally parallel disposed fixed arms.

6. The implement attachment of claim 5, the respective fixed arms having a respective support portion and a respective rock engaging portion, the support portion and rock engaging portion of arm member being formed integrally and unitarily.

7. The implement attachment of claim 6, a respective support portion defining greater than a right angle with respect to an associated rock engaging portion.

8. The implement attachment of claim 7, wherein each respective rock engaging portion having a penetrator fixedly coupled to a lower face of the rock engaging portion.

9. The implement attachment of claim 8 wherein each respective penetrator presents a forward directed pointed tip.

10. The implement attachment of claim 1, wherein the shiftable arm member includes an upright support member and a shiftable arm member, the shiftable arm member being hingedly coupled to the upright support member.

11. The implement attachment of claim 10, wherein the upright support member is fixedly coupled to the back plate member and to a pair of generally parallelly disposed flanges, each of the flanges being fixedly coupled to the foreside of the back plate member.

12. The implement attachment of claim 11, wherein the shiftable arm member includes an extending portion and a depending portion, the depending portion defining an acute angle with respect to the extending portion.

13. The implement attachment of claim 12, wherein the shiftable arm member includes an actuator disposed generally parallel to and spaced apart from the extending portion of the shiftable arm member.

14. The implement attachment of claim 1 wherein the shiftable arm member is disposed relative to the fixed arms member to define a jaws therebetween, the jaws being openable and closeable to define a variable gap and the jaws being openable and closeable by means of an actuator disposed generally parallel to and spaced apart from the extending portion of the shiftable arm member.

15. The implement attachment of claim 1 wherein the shiftable arm member is disposed relative to the fixed arms member of the fixed arms member centrally with respect to the space defined between the fixed arms member.

16. The implement attachment of claim 14 wherein a first end of the actuator is operably coupled to the backplate member and an opposed second end thereof is operably coupled to the shiftable arm member

17. A method of forming an implement attachment, the implement attachment being a rock picker attachment, including:
forming a back plate member;
fixedly coupling a fixed arms member to the back plate member;
operably, shiftably coupling a shiftable arm member to the back plate member; and
defining a variable gap between the shiftable arm member and the fixed arms member.
